(19) United States
(12) Patent Application Publication
(10) Pub. No.: US 2004/0255308 A1
(43) Pub. Date: Dec. 16, 2004

(54) Method and system for activity-based user interfaces

(75) Inventors: Roy Leban, Redmond, WA (US); Amar S. Gandhi, Redmond, WA (US); Shaheeda Parveen, Redmond, WA (US); Don Gillett, Bellevue, WA (US); Kenny Young, Sammamish, WA (US); Andrew Boardman, Bellevue, WA (US); Jane R. Liles, Seattle, WA (US)

Correspondence Address: Robert T. Neufeld, Esq., KING & SPALDING LLP, 45th Floor, 191 Peachtree Street, N.E., Atlanta, GA, 30303, US

(73) Assignee: Microsoft Corporation, Redmond, WA

(21) Appl. No.: 10/463,625

(22) Filed: Jun. 16, 2003

(51) Int. Cl. G06F 13/00

(52) U.S. Cl. 719/328; 719/329

(57) ABSTRACT

A computer-implemented method and system for displaying data from a plurality of sources within a single user interface. The method and system improves upon existing GUIs by presenting content from a plurality of software applications or other data sources simultaneously within a single user interface. The method and system can continuously poll other applications and data sources to update the data displayed in the user interface. The method and system can also receive pushed data from other applications and data sources. The user interface can be displayed simultaneously with the GUI of another application. The user interface allows a user to monitor content from several different software applications while working in a distinct software application.

### TECHNICAL FIELD

The present invention is generally directed to a graphical user interface. More specifically, the present invention provides a method and system for presenting data from a variety of sources in a graphical user interface.

### BACKGROUND OF THE INVENTION

User interfaces are commonly used in computing to facilitate communication between the user and the computing device. The first user interfaces were text and keyboard based, such as the commands used in the DOS operating system. Using a keyboard, the user could enter specific commands that would be understood by the operating system. An improvement on the original command interface used menus to provide a user with choices that could be selected with a pointing device, such as a mouse. More recently, graphical menus have been greatly enhanced and are now generally referred to as graphical user interfaces (“GUIs”). GUIs have become the common means for communication between a user and a computing device. A GUI typically supports communication using understandable symbols and words such as icons, scroll bars, buttons, and menus. GUIs are typically presented to the user as part of the computing device's operating system or as part of an application running on the computing device.

A problem with existing GUIs is that they are either tied to the operating system or to a specific application operating on the computing device. Operating system GUIs are relatively high-level in that they provide general information such as icons representing various software applications available on the computing device. Another example of information conveyed by the operating system GUI is the tray located on the tool bar at the bottom of current Windows operating systems. For example, when an email software module has received a new email message, the email software module will send a signal to the operating system GUI to display an icon in the tray. The icon lets the user know that a new email message has arrived. The tray may also indicate what software modules are currently running on the computer device and what hardware components are available. However, the information the operating system GUI provides is relatively limited. The operating system GUI does not provide information about content from a particular application.

In contrast, software applications, such as Word, generally have a highly detailed GUI. The Word GUI displays a variety of icons, symbols, scroll bars, buttons, and menus that facilitate use of the wide variety of functions available in the application. The Word GUI provides a great amount of detail to the user about the functions and options available for use in creating a document. However, the Word GUI is limited to functions and options available in the Word software application. In other words, the Word GUI does not provide information from other software modules.

These limitations of conventional GUIs are particularly evident in the area of conferencing or meeting software applications. Conferencing software is generally designed to support meetings electronically, irrespective of whether the meeting participants are remotely located or are face to face. Conferencing software allows people to more readily use computing devices as part of a meeting. Computing devices used in a meeting can include a conventional PC, a PDA, and a telephone. The goal of meeting software is to allow the participants to collaborate electronically. Collaboration can take place by reviewing or assigning agenda items, sharing messages, or working in an electronic document.

However, meetings typically involve information from a variety of different sources or working with multiple software applications. People participating in a meeting that is held using a conferencing software application may want to access calendar information, agenda information, the participants' identities, electronic documents related to the meeting, or data related to the meeting. Conventional conferencing software applications do not provide users with a useful GUI that collects data from a variety of different software modules. The GUI in conventional conferencing software applications does not allow a user to monitor information from several different sources outside of the conferencing application. Conventional conferencing software also does not allow for displaying the conferencing GUI and a GUI from another application simultaneously.

In view of the foregoing, a need exists for a GUI that allows a user to communicate with several software applications simultaneously. Specifically, there is a need for a GUI that gathers information from more than one software module and presents it to the user in a convenient format. There is a further need to display a conferencing GUI simultaneously with a GUI from another application so that a user can continuously monitor information from the conferencing GUI.

### SUMMARY OF THE INVENTION

The present invention is generally directed to a software module for rendering a user interface. The present invention improves upon existing user interfaces that are constrained to a particular application or operating system. Specifically, a conferencing software module can gather data from several different software applications and present this data to the user in a useful format. The conferencing software module renders the gathered data in a user interface that can be positioned off to the side of the computing device's display. The conferencing software module's user interface presents the gathered data for the user while also allowing other user interfaces to be displayed simultaneously.

In one aspect, the invention comprises a method for displaying data from multiple sources to a user. Specifically, the conferencing software module supports displaying data used during a meeting. A user can set up a meeting with other users connected to the conferencing software module running on a server. The meeting organizer can input meeting data, such as the start time, the expected attendees, the meeting agenda, relevant files, and links to other relevant data into the conferencing software module. A communications module, such as an email application, can prompt each user at the start of the meeting. The conferencing software module can also receive the prompt from the email application that a meeting is about to begin. In response to the prompt, the conferencing software module can open a conferencing user interface on the computing devices of users connected to the server. The conferencing software module also transmits the meeting data to each of the users connected to the server so that the meeting data can be displayed in the conferencing user interface.

The invention further provides a method for displaying meeting data to distributed computing devices that are not connected to a central server. A meeting organizer can set up a meeting by entering meeting data into a conferencing software module. The meeting organizer can send the other attendees an electronic prompt, such as an email message, when the meeting is about to begin. The email message can also include the meeting data. A conferencing software module on another attendees computing device can detect the email message and open a conferencing user interface. The conferencing software module can also locate the meeting data included with the email message and render that data in the conferencing user interface. The other attendees to the meeting can view the same meeting data for a more productive meeting.

In yet another aspect, the invention provides a computer-implemented method for viewing information from multiple software applications simultaneously on a computing device. A conferencing software module can be set to collect data from other software applications that are running on the computing device. While the user interface for one software application is open on the computing device, a smaller or more convenient conferencing user interface can also be open simultaneously. The conferencing software module can collect data from other software applications identified by the user that are running on the computing device. The data collected from the other software applications is presented to the user in a convenient format in the conferencing user interface.

Lastly, the invention also includes a computer system for providing a user with information from a plurality of software applications simultaneously. The system can be implemented in a traditional client-server architecture with a conferencing module residing on the server. Multiple clients coupled to the server can receive information from the conferencing software module. The conferencing software module can display a conferencing user interface on each of the clients. Information the conferencing software module collects from various software applications is rendered in each conferencing user interface on each client. Each client is capable of displaying the same information in the conferencing user interface simultaneously.

These and other aspects of the invention will be described in the detailed description in connection with the drawing set and claim set.

### BRIEF DESCRIPTION OF THE DRAWINGS

FIG. 1 is a block diagram illustrating an exemplary operating environment for implementing various embodiments of the present invention.

FIG. 2 is a block diagram illustrating an exemplary architecture of a client-server computing environment in which the invention can operate.

FIG. 3 is a logic flow diagram illustrating an overview of an exemplary process for using a conferencing user interface in association with the exemplary architecture illustrated in FIG. 2.

FIG. 4 is a logic flow diagram illustrating an exemplary process for retrieving meeting data in association with the exemplary process illustrated in FIG. 3.

FIG. 5 is a block diagram illustrating an exemplary data scheme for arranging data associated with the conferencing module.

FIG. 6 is a block diagram illustrating an exemplary architecture of a distributed computing environment in which the invention can operate.

FIG. 7 is a logic flow diagram illustrating an overview of an exemplary process for using a conferencing user interface in association with the exemplary architecture illustrated in FIG. 6.

FIG. 8 is a logic flow diagram illustrating an exemplary process for retrieving meeting data in association with the exemplary process illustrated in FIG. 7.

FIG. 9 is an exemplary screen display showing a conferencing user interface associated with a conferencing module.

### DETAILED DESCRIPTION OF THE EXEMPLARY EMBODIMENTS

The present invention supports displaying information from a plurality of sources in a convenient user interface. The user interface can receive and display information from a variety of different software applications and data sources. The user interface can also display this information simultaneously with a user interface from another application. The present invention allows a user to monitor information from variety of other sources. While the information from other sources is displayed in the user interface, the user can work within a GUI for a specific application. For example, a single user can rely on the user interface to display information from an email application, a voicemail application, and an electronic calendar, while simultaneously reviewing a Website with a distinct browser application. Because the user interface is independent of a specific application or the operating system, it can display information from multiple sources simultaneously.

While the invention will be described in the foregoing embodiments in the context of meetings held between multiple computing devices, the present invention can also be implemented outside of the traditional meeting context. In the meeting scenario, the user interface is typically referred to as a conferencing user interface and the data it displays as meeting data. In alternative embodiments beyond the meeting context, the user interface is more generally referred to as an activity-based user interface and the data it provides to the user is activity data. Activity data can be gathered from a plurality of electronic sources and presented to the user in a convenient manner with the activity-based user interface.

Those skilled in the art will recognize that the present invention can also be implemented on a personal computer or in conjunction with other program modules for other types of computers. Furthermore, those skilled in the art will recognize that the present invention may be implemented in a stand-alone or in a distributed computing environment. In a distributed computing environment, program modules may be physically located in different local and remote memory storage devices. Execution of the program modules may occur locally in a stand-alone manner or remotely in a client/server manner. Examples of such distributed computing environments include local area networks of an office, enterprise-wide computer networks, and the global Internet.

The detailed description which follows is represented largely in terms of processes and symbolic representations of operations by conventional computer components, including processing units, memory storage devices, display devices and input devices. These processes and operations may utilize conventional computer components in a distributed computing environment, including remote file servers, remote computer servers, and remote memory storage devices. Each of these conventional distributed computing components is accessible by a processing unit via a communications network.

The processes and operations performed by the computer include the manipulation of signals by a processing unit or remote server and the maintenance of these signals within data structures resident in one or more of the local or remote memory storage devices. Such data structures impose a physical organization upon the collection of data stored within a memory storage device and represent specific electrical or magnetic elements. These symbolic representations are the means used by those skilled in the art of computer programming and computer construction to most effectively convey teachings and discoveries to others skilled in the art.

The present invention includes a computer program which embodies the functions described herein and illustrated in the appended flow charts (or logic flow diagrams). However, it should be apparent that there could be many different ways of implementing the invention in computer programming, and the invention should not be construed as limited to any one set of computer program instructions. Further, a skilled programmer would be able to write such a computer program to implement the disclosed invention without difficulty based on the flow charts and associated description in the application text, for example. Therefore, disclosure of a particular set of program code instructions is not considered necessary for an adequate understanding of how to make and use the present invention. The inventive functionality of the claimed computer program will be explained in more detail in the following description in conjunction with the remaining figures illustrating the program flow.

Referring now to the drawings, in which like numerals represent like elements throughout the several figures, aspects of the present invention and an exemplary operating environment for the implementation of the present invention will be described.

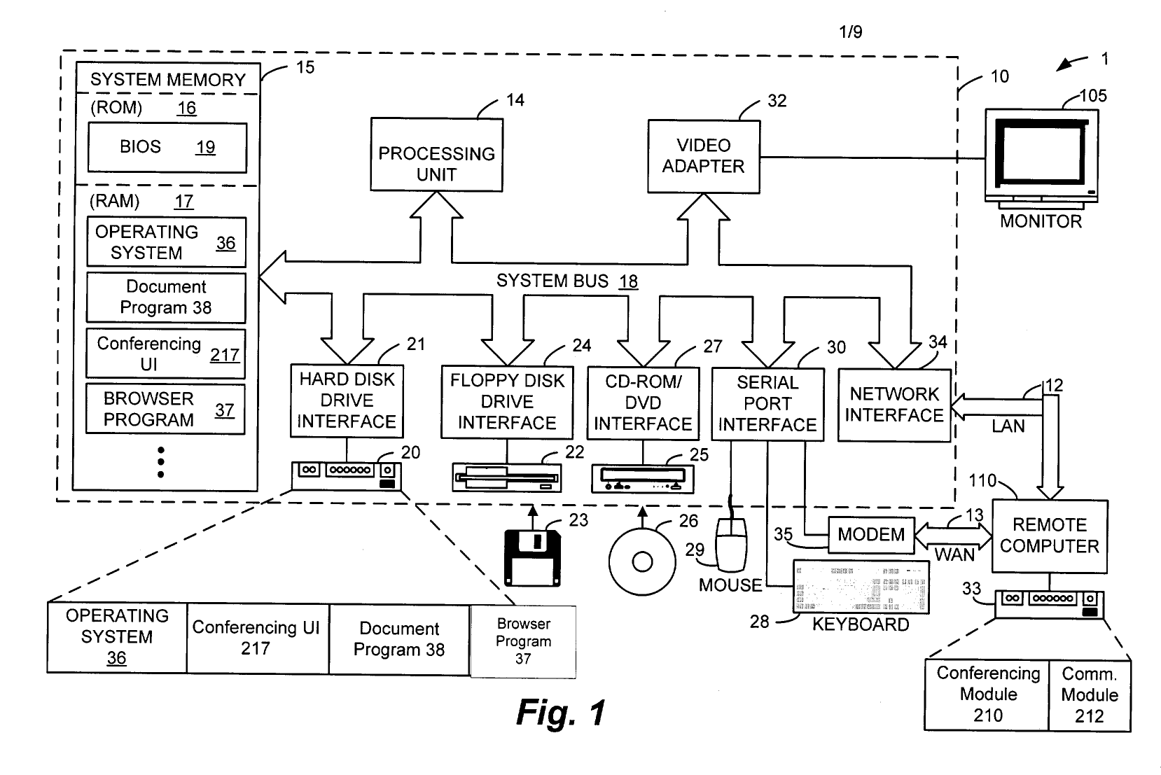

FIG. 1 is a block diagram illustrating an exemplary operating environment 1 for implementation of various embodiments of the present invention. Those skilled in the art will appreciate that FIG. 1 and the associated discussion are intended to provide a brief, general description of one exemplary embodiment of computer hardware and program modules, and that additional information is readily available in appropriate programming manuals, user's guides, and similar publications.

The exemplary operating environment 1 illustrated in FIG. 1 includes a general-purpose computing device that can be in the form of a conventional personal computer 10. As shown in FIG. 1, the personal computer 10 operates in a networked environment with logical connections to a remote server 11. The logical connections between the personal computer 10 and the remote server 11 are represented by a local area network 12 and a wide area network 13. Those of ordinary skill in the art will recognize that in this client/server configuration, the remote server 11 may function as a file server or computer server.

The personal computer 10 includes a processing unit 14, such as a “PENTIUM” microprocessor manufactured by Intel Corporation of Santa Clara, Calif. The personal computer also includes system memory 15, including read only memory (ROM) 16 and random access memory (RAM) 17, which is connected to the processor 14 by a system bus 18. An exemplary embodiment of the computer 10 utilizes a basic input/output system (BIOS) 19, which is stored in the ROM 16. Those skilled in the art will recognize that the BIOS 19 is a set of basic routines that helps to transfer information between elements of the personal computer 10. Those skilled in the art will also appreciate that the present invention may be implemented on computers having other architectures, such as computers that do not use a BIOS 19, and those that utilize other types of microprocessors for a processing unit 14.

Within the personal computer 10, a local hard disk drive 20 is connected to the system bus 18 via a hard disk drive interface 21. A floppy disk drive 22, which is used to read or write to a floppy disk 23, is connected to the system bus 18 via a floppy disk drive interface 24. A CD-ROM or DVD drive 25, which is used to read a CD-ROM or DVD disk 26, is connected to the system bus 18 via a CD-ROM or DVD interface 27.

A user can enter commands and information into the personal computer 10 by using input devices, such as a keyboard 28 and/or pointing device, such as a mouse 29, which are connected to the system bus 18 via a serial port interface 30. Other types of pointing devices (not shown in FIG. 1) include track pads, track balls, digitizer pens, head trackers, data gloves, and other devices suitable for positioning a cursor on a monitor 31. The monitor 31 or other kind of display device is connected to the system bus 18 via a video adapter 32.

As depicted in FIG. 1, a number of program modules can be stored on ROM 16, RAM 17, hard disk 21, floppy disk 23, or CD-ROM/DVD disk 26, such as an operating system 36, a conferencing user interface 217, a browser program module 37, and a document program 38. Program modules include routines, subroutines, programs, objects, components, data structures, etc., which perform particular tasks or implement particular abstract data types.

The remote server 11 in this networked environment is connected to a remote memory storage device 33. This remote memory storage device 33 is typically a large capacity device such as a hard disk drive, CD-ROM or DVD drive, magneto-optical drive or the like. Those skilled in the art will understand that program modules, such as a conferencing module 210, are provided to the remote server 11 via computer-readable media. The personal computer 10 is connected to the remote server 11 by a network interface 34, which is used to communicate over a local area network (LAN) 12.

In some embodiments, the personal computer 10 is also connected to the remote server 11 by a modem 35, which is used to communicate over a wide area network (WAN) 13, such as the Internet. The modem 35 is connected to the system bus 18 via the serial port interface 30. The modem 35 also can be connected to the public switched telephone network (PSTN) or community antenna television (CATV) network. Although illustrated in FIG. 1 as external to the personal computer 10, those of ordinary skill in the art can recognize that the modem 35 may also be internal to the personal computer 10, thus communicating directly via the system bus 18. It is important to note that connection to the remote server 11 via both the LAN 12 and the WAN 13 is not required, but merely illustrates alternative methods of providing a communication path between the personal computer 10 and the remote server 11.

Those skilled in the art will appreciate that program modules, such as the operating system 36, the conferencing user interface 217, the browser program module 37, and the document program 38 can be provided to the personal computer 10 via computer-readable media. In exemplary embodiments of the operating environment 1, the computer-readable media can include the local or remote memory storage devices, which may include the local hard disk drive 20, floppy disk 23, CD-ROM/DVD 26, RAM 17, ROM 16, and the remote memory storage device 33. In some exemplary embodiments of the personal computer 10, the local hard disk drive 20 is used to store data and programs.

Although other elements of the personal computer 10 and the operating environment 1 in general are not shown, those of ordinary skill in the art will appreciate that such components and the interconnection between them are known. Accordingly, additional details concerning the elements of the personal computer 10 and the operating environment 1 in general need not be disclosed in connection with the present invention for it to be implemented by those of ordinary skill in the art.

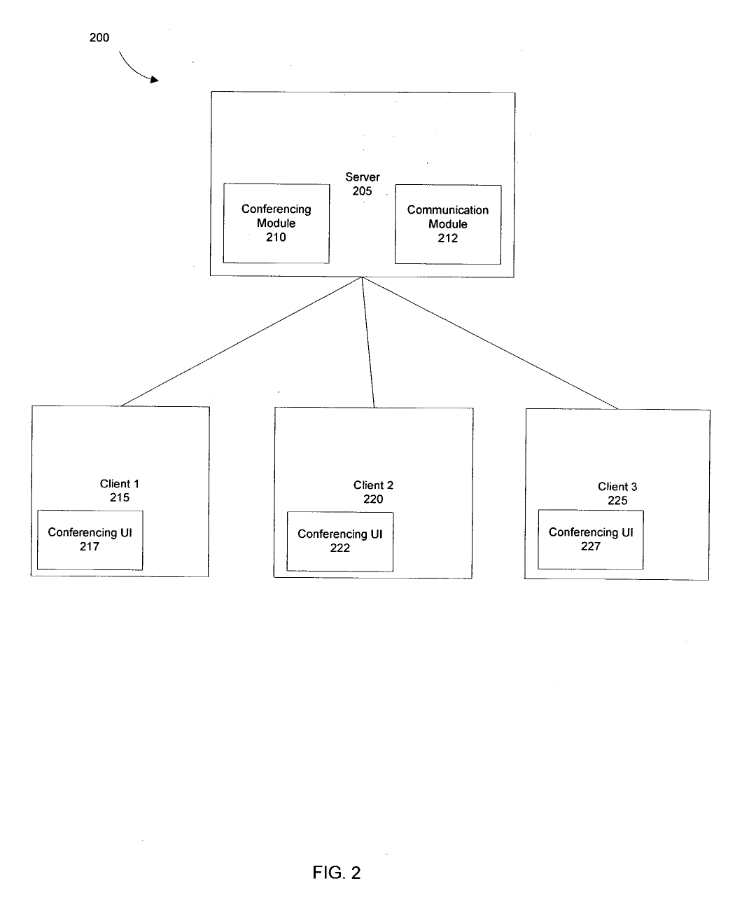

Referring now to FIG. 2, an exemplary embodiment for implementing the present invention is illustrated. The exemplary architecture 200 illustrated in FIG. 2 comprises a client1 215, client2 220, and client3 225 coupled to a server 205. Although the exemplary architecture 200 illustrates three clients coupled to server 205, in alternative embodiments of the invention greater or fewer clients may be coupled to server 205. A conferencing module 210 operating on server 205 supports electronic conferencing between users operating client1 215, clients2 220, and client3 225. The conferencing module 210 provides a central electronic workspace in which users can conduct an electronic conference. Conferencing module 210 typically comprises, among other features, an electronic white board that allows users to collaborate electronically. Also operating on the server 205 is a communication module 212. An e-mail server module is a typical communication module 212 that can be used in conjunction with a conferencing module 210 to support communication among the clients.

Among the other software applications typically run on a client, client1 215, client2 220, and client3 225 in the exemplary architecture 200 also have a conferencing user interface. The conferencing user interface 217 can be rendered on a client1 215 by the conferencing module 210. Alternatively, the conferencing user interface 217 can also be rendered by a distinct conferencing module operating on client1 215. The conferencing user interface 217 works in conjunction with the conferencing module 210 to display data to the user operating client1 215.

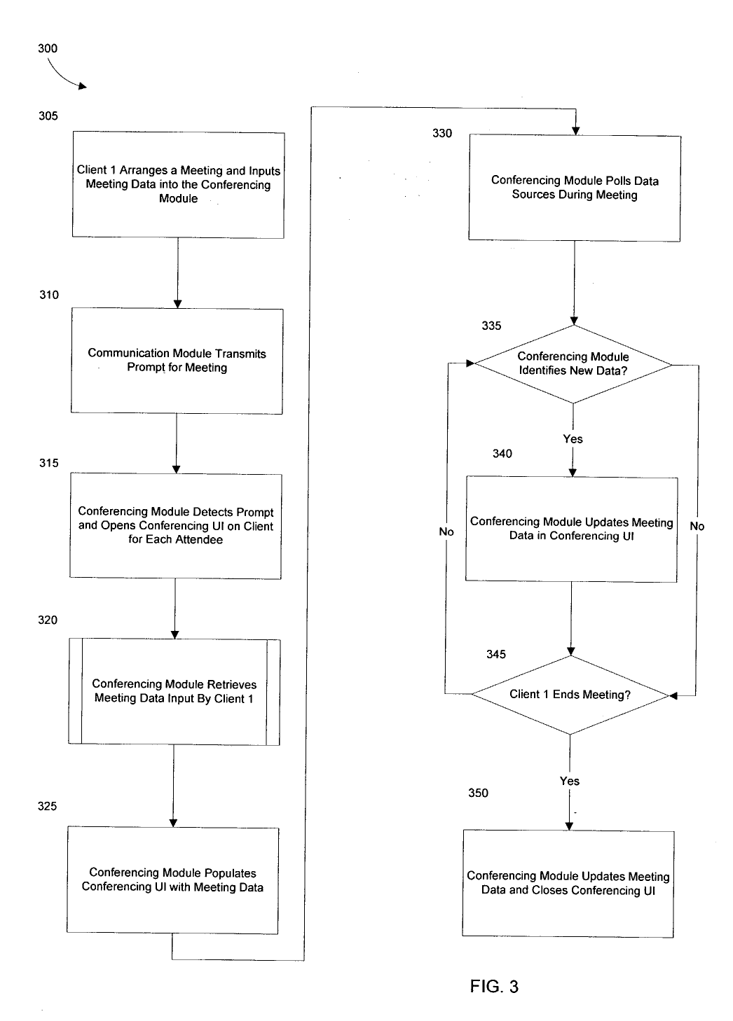

An exemplary process 300 is illustrated in FIG. 3 for operating one embodiment of the present invention. The exemplary process 300 illustrates a method of using the conferencing user interface 217 in conjunction with the client-server architecture illustrated in FIG. 2. Those skilled in the art will understand that in alternative embodiments of the present invention the steps illustrated in exemplary process 300 may be performed in alternative sequences and certain steps can be removed or added.

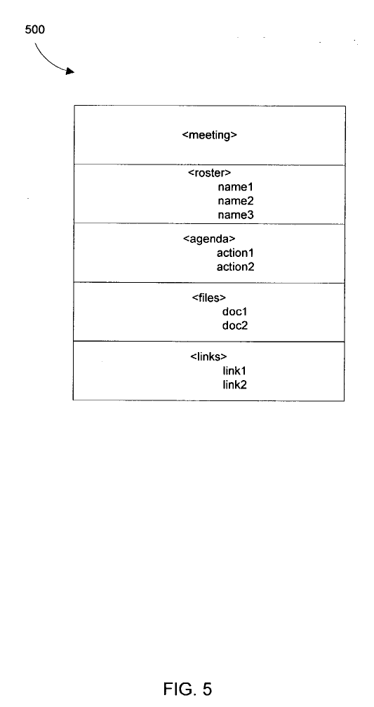

Referring to step 305 of process 300, a user operating client1 215 arranges a meeting and inputs meeting data into the conferencing module 210. Meeting data can include the start time for the meeting, the participants in the meeting, an agenda for the meeting, and documents and data associated with the meeting. An exemplary meeting data format 500 is illustrated in FIG. 5. In addition to transmitting the meeting data to the conferencing module 210, client1 215 can also transmit a start time to an electronic calendar associated with the communication module 212. The transmission setting the meeting time with the communication module 212 can also specify the clients that are expected to attend the meeting. In step 310, as the meeting approaches, the communication module 212 will transmit a prompt for the meeting to the clients associated with the meeting. In the exemplary architecture illustrated in FIG. 200, the communication module 212 can send an electronic message to client1 215, client2 220, and client3 225 indicating the start of the meeting is approaching.

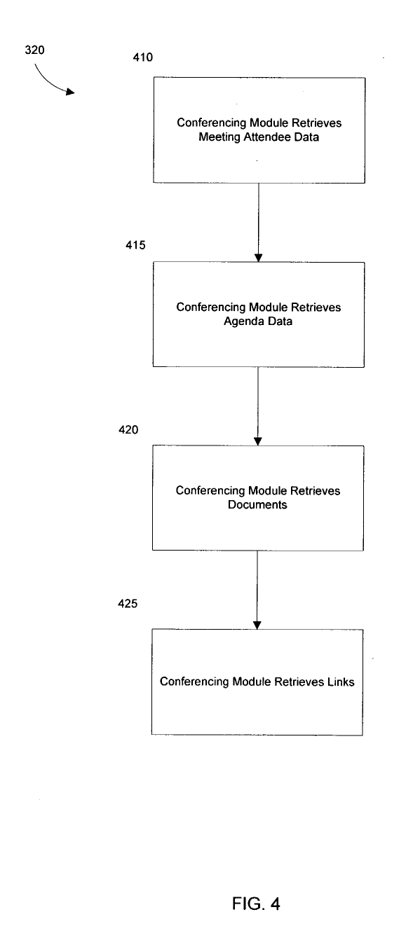

In step 315, the conferencing module 210 detects the prompt transmitted by communication module 212 and opens a conferencing user interface on each of the clients coupled to server 205. Alternatively, as each of the clients receives the prompt from the communication module 212, a conferencing module located on the client can render the conferencing user interface. In step 320, the conferencing module 210 retrieves the meeting data that was previously transmitted from client1 215 in step 305. An exemplary process for completing step 320 is illustrated in greater detail in FIG. 4. In steps 410 through 425 the conferencing module 210 retrieves the various pieces of meeting data 500 input by the organizer of the meeting. The meeting data illustrated in FIG. 5 and the steps for collecting that meeting data illustrated in FIG. 4 are merely illustrative. In alternative embodiments of the present invention the steps illustrated in FIG. 4 may be performed in a different order and certain steps may be added or removed for different data formats.

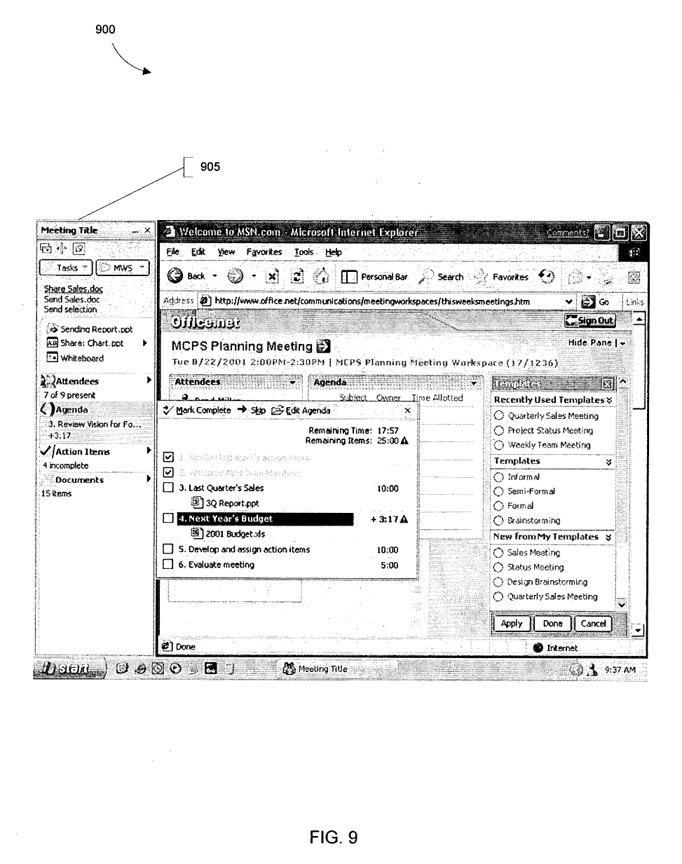

In step 325, the conferencing module 210 populates the conferencing user interface 217 with the retrieved meeting data 500. An exemplary illustration of the conferencing user interface 217 is shown in FIG. 9. As illustrated in FIG. 9, the conferencing user interface 905 can be displayed simultaneously with another user interface. The information that can be displayed in the conferencing user interface 905 includes the attendees for the meeting, the agenda for the meeting and documents associated with the meeting. The items in the conferencing user interface 905 can be further expanded to provide additional information such as further details about the agenda items or the specific names of the documents associated with the meetings. The amount and types of information displayed in the conferencing user interface 905 can be controlled by the user. In alternative embodiments, the conferencing user interface 217 can display information from the user's voicemail application, from the user's e-mail application, and from an electronic calendar application, for example. Furthermore, multiple instances of the conferencing user interface 217 can be open simultaneously with a user interface of another application. For example, one instance of the conferencing user interface 217 can display information pertaining to a particular meeting, while a second instance of the conferencing user interface 217 can display content from an e-mail application and an electronic calendar application.

Referring again to exemplary process 300 illustrated in FIG. 3, in step 330 the conferencing module 210 can poll the various sources of the meeting data. Typically, the conferencing module 210 would use pointers to the various applications from which the meeting data is derived. As a user is working in another application or as the meeting progresses, the conferencing module 210 retrieves new data from the various applications. In addition to the conferencing module 210 pulling new data from the various applications, data sources can also push new data to the conferencing user interface 217 for display. In step 335, if the conferencing module 210 does identify new meeting data, it retrieves or receives that new meeting data and updates the information displayed in the conferencing user interface 217 in step 340.

Typically, the meeting will progress until the meeting organizer decides to end the meeting. If, in step 345, client1 215 sends a signal to the conferencing module 210 to terminate the meeting, the conferencing module will save the most current version of the meeting data in step 350. The user also can set different options to control whether meeting data is saved automatically. In step 350, the conferencing module 210 can also close the conferencing user interface 217. Alternatively, if the user is relying on the conferencing user interface 217 to display other information not associated with the particular meeting, the user can choose to keep the conferencing user interface 217 open.

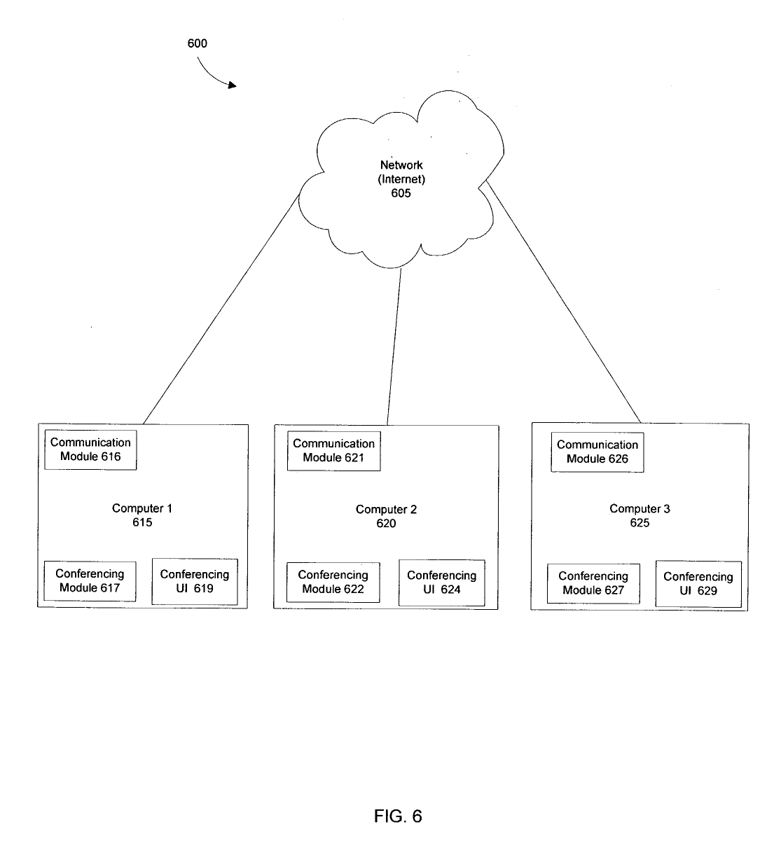

The client-server architecture 210 illustrated in FIG. 2, is merely one embodiment for implementing the conferencing user interface. One advantage of the client-server architecture 200 is that the centralized conferencing module 210 can supporting sharing of data among various clients in real time. Alternatively, the conferencing user interface can also be implemented without a central conferencing module such as in the distributed architecture 600 illustrated in FIG. 6. The exemplary architecture 600 comprises three computing devices 615, 620, and 625, coupled to a network such as the Internet 605. As an example, computer1 615 is a computing device with several software modules running on it. Computer1 615 comprises a communication module 616 such as an e-mail program used to communicate with computer2 620 and computer3 625. A conferencing software module 617 is used to share data in a conferencing mode with computer2 620 and computer3 625. Computer1 615 also comprises a conferencing user interface 619 for displaying information from a plurality of software modules or data sources. Instead of the central conferencing module 210 illustrated in FIG. 2, in the distributed architecture 600, the clients use individual conferencing modules to communicate directly without a central location for the meeting data.

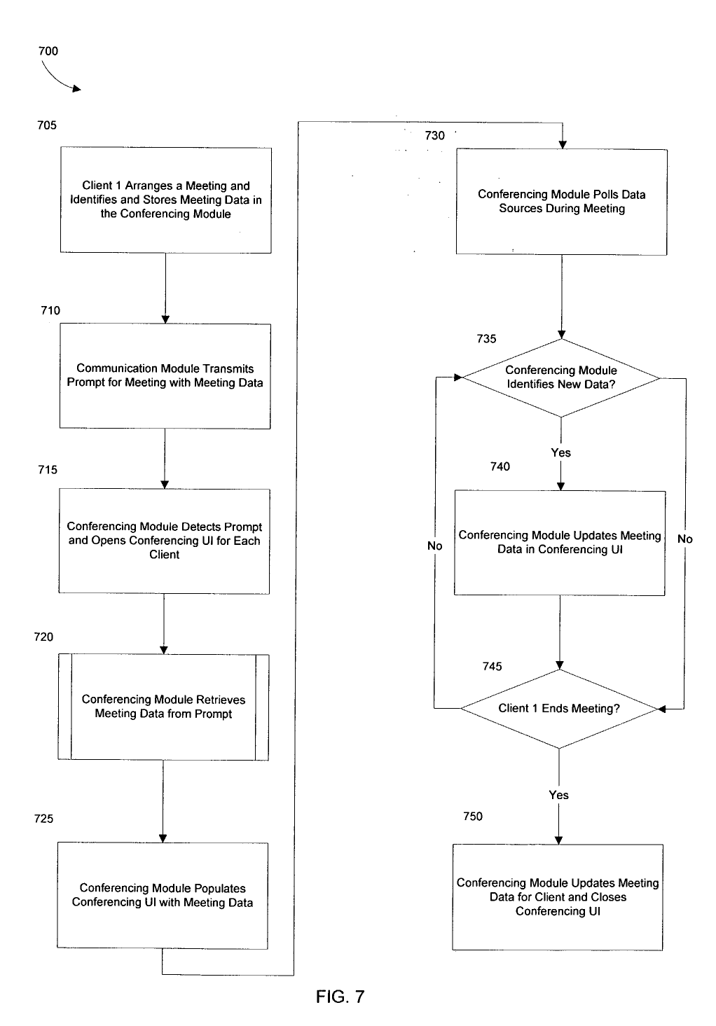

FIG. 7 illustrates an exemplary process 700 for using a conferencing user interface in connection with the distributed architecture illustrated in FIG. 6. In step 705, computer1 615 arranges a meeting with other people operating computer2 620 and computer3 625. In association with arranging the meeting, the user operating computer1 615 will also identify and store meeting data 500 in the conferencing module 617. The meeting data can also include scheduling a start time for the meeting using an electronic calendar. In step 710, as the time approaches for the scheduled meeting the communication module 616 transmits an electronic prompt to computer2 620 and computer3 625 to advise of the beginning of the meeting. Typically, the electronic prompt would be transmitted shortly before the start of the meeting. The electronic prompt can take the form of an e-mail message notifying computer2 620 and computer3 625 of the start time of the meeting. The e-mail message can also contain an attachment with the meeting data 500 provided by the conferencing module 617. In alternative embodiments of the present invention, computer1 615 may transmit an electronic message to computer2 620 and computer3 625 in advance of the meeting with the meeting data attached. In such an embodiment, electronic calendaring applications residing on computer2 620 and computer3 625 may simply provide a prompt shortly before the start of the meeting.

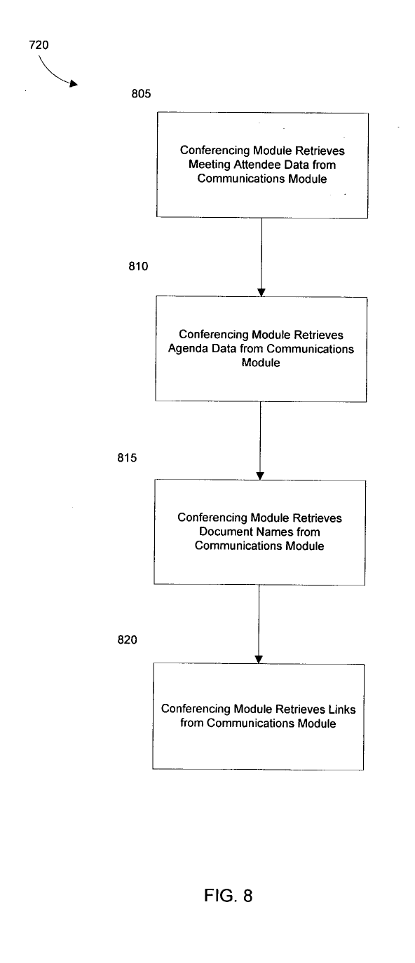

In step 715 of the exemplary process 700, the conferencing module 622 on computer2 620 detects the prompt for the start of the meeting and opens the conferencing user interface 624. If the user already has the conferencing user interface 624 open, the exemplary process 700 will simply proceed to step 720. In step 720, the conferencing module 622 retrieves the meeting data 500 from the electronic message that was transmitted from computer1 615. Alternatively, the meeting data 500 may have been previously transmitted and already stored in the conferencing module 622. An exemplary process for accomplishing step 720 is illustrated in greater detail in FIG. 8. The exemplary process illustrated in FIG. 8 concerns meeting data 500 that has been attached to an electronic message received at the communications module 621. In steps 805 through 820 of exemplary process 720, the conferencing module 622 retrieves the respective pieces of meeting data 500 from the electronic message received at the communication module 621. In alternative embodiments of the present invention the conferencing module 622 may retrieve greater or fewer pieces of meeting data from the communications module 621 than shown in the exemplary process 720. The meeting data may also simply comprise an address or location where additional meeting data can be retrieved.

In step 725, the conferencing module 622 populates the conferencing user interface 624 with the retrieved meeting data 500. An exemplary screen display illustrating a conferencing user interface 624 in greater detail is provided in FIG. 9. While the meeting is going on, the conferencing module 622 can poll the sources of the meeting data 500 for more current information. The polling typically occurs using pointers included with the original meeting data provided to the conferencing module 622. The pointers indicate the appropriate software module or data source for the meeting data.

The conferencing module 622 can establish a connection with other software applications that may be providing new data for the conferencing user interface 624. For example, the conferencing module 622 can continuously poll an e-mail application for new data to be displayed in the conferencing user interface. In one embodiment, the conferencing user interface 624 displays the sender and the subject line for the email. In alternative embodiments of the present invention, software applications and other sources of meeting data may also push new data to the conferencing module 622.

In step 735, if the conferencing module 622 identifies new data, it will update the data displayed in the conferencing user interface 624. For example, in the exemplary screen display illustrated in FIG. 9, the conferencing software module 622 may receive data concerning revisions to a document identified in the conferencing user interface 624. The conferencing module 622 can select portions of this data, such as the revised title of the document, and display the new data in the conferencing user interface 624. As another example, the conferencing module 622 may receive a revised agenda for the meeting associated with the displayed meeting data. The conferencing user interface 624 will receive the new information identifying the revised agenda and display that information in the conferencing user interface 624.

If the organizer of the meeting decides to end the meeting, in step 745, computer1 615 can transmit a signal to computer2 620 and computer3 625 indicating the end of the meeting. In step 750, the conferencing module 617 can update the current meeting data for that meeting and store the data for future use. In step 750, upon terminating the meeting, the conferencing module 617 may also close the conferencing user interface 619. In alternative embodiments of the present invention the user can continue to use the conferencing user interface 619 even after the meeting has ended. For example, the user operating computer1 615 could be playing an electronic game while also monitoring information from other applications displayed in the conferencing user interface 619.

In conclusion, the present invention enables users to view content from a variety of software applications and other data sources simultaneously. The conferencing user interface can collect information from the different software applications and data sources and present this information to the user in a convenient format. The conferencing user interface can also receive information pushed to it from applications. The conferencing user interface can be displayed simultaneously with another GUI. Displaying the conferencing user interface simultaneously with another GUI allows a user to work within one application while monitoring information from several other applications.

It will be appreciated that the present invention fulfills the needs of the prior art described herein and meets the above-stated objects. While there has been shown and described several exemplary embodiments of the present invention, it will be evident to those skilled in the art that various modifications and changes may be made thereto without departing from the spirit and the scope of the present invention as set forth in the appended claims and equivalents thereof. For instance, the conferencing user interface, also referred to as an activity-based user interface, can be used beyond the meeting environment. In particular, the conferencing user interface can be implemented on a single computing device to monitor data from a variety of applications simultaneously.

What is claimed is:

1. A computer-implemented method for displaying information from a plurality of sources in a graphical user interface displayed on one or more clients coupled to a server, comprising:
receiving meeting data for a meeting from a first client, wherein the meeting data comprises data from at least two different software modules;
transmitting a prompt for the beginning of the meeting from the server to the first client, a second client, and a conferencing module associated with the server;
rendering a conferencing user interface for display on the first client and the second client, the conferencing user interface operable for displaying the meeting data; and
transmitting the meeting data to the first client and the second client.

2. The method of claim 1, further comprising the step of displaying the meeting data in the conferencing user interface displayed on the first client and the second client

3. The method of claim 1, wherein the meeting data comprises at least two of attendee data, agenda data, data from a browser application, data from a document application, data from a server application, and data from a database application.

4. The method of claim 1, wherein the meeting data comprises content from a software application.

5. The method of claim 1, wherein the meeting data comprises names of documents relevant to the meeting.

6. The method of claim 1, further comprising the step of polling another software application to update the meeting data.

7. A computer-readable medium having computer-executable instructions for performing the steps recited in claim 1.

8. A computer-implemented method for displaying activity data from a plurality of sources in an activity-based user interface displayed on a client coupled to a server, comprising:
receiving an electronic message at the client from the server indicating the beginning of an activity;
displaying an activity-based user interface at the client;
receiving the activity data at the client from the server, wherein the activity data is from at least two different software modules; and
making the activity data accessible with the activity-based user interface displayed at the client.

9. The method of claim 8, wherein the step of making the activity data accessible further comprises displaying the activity data in the activity-based user interface.

10. The method of claim 8, wherein the activity data comprises at least two of calendar data, email data, data from a browser application, data from a document application, data from a server application, and data from a database application.

11. The method of claim 8, wherein the activity data comprises content from a software application.

12. The method of claim 8, further comprising the step of polling one of the software modules for current activity data.

13. The method of claim 8, further comprising the step of storing the activity data at the server.

14. A computer-readable medium having computer-executable instructions for performing the steps recited in claim 8.

15. A computer-implemented method for displaying information from a plurality of sources in a graphical user interface displayed on two coupled computing devices, comprising:
inputting meeting data associated with a meeting into a conferencing module at a first computing device, the meeting data comprising data from at least two different software modules;
transmitting an electronic message with the meeting data from the first computing device to a second computing device indicating the start of the meeting;
in response to the electronic message, opening a conferencing user interface at the second computing device; and
rendering the meeting data from the electronic message in the conferencing user interface at the second computing device.

16. The method of claim 15, further comprising the step of rendering the meeting data from the electronic message in the conferencing user interface displayed at the first computing device.

17. The method of claim 15, wherein the meeting data comprises at least two of attendee data, agenda data, data from a browser application, data from a document application, data from a server application, and data from a database application.

18. The method of claim 15, further comprising the step of transmitting an electronic message from the first computing device indicating the end of the meeting.

19. The method of claim 15, wherein the meeting data comprises content from a software application.

20. The method of claim 15, further comprising the step of receiving updated meeting data from a software application.

21. A computer-readable medium having computer-executable instructions for performing the steps recited in claim 15.

22. A computer-implemented method for displaying information from a plurality of sources in an activity-based user interface displayed on two coupled computing devices, comprising:
transmitting an electronic message comprising activity data from a first computing device to a second computing device indicating the start of an activity, wherein the activity data comprises data from at least two different software modules;
in response to the electronic message, rendering an activity-based user interface at the second computing device; and
displaying the activity data in the activity-based user interface.

23. The method of claim 22, further comprising the step of retrieving the activity data from the electronic message with a conferencing module.

24. The method of claim 22, wherein the activity data comprises at least two of calendar data, email data, data from a browser application, data from a document application, data from a server application, and data from a database application.

25. The method of claim 22, wherein the activity data comprises content from a software application.

26. The method of claim 22, further comprising the step of storing the activity data in a conferencing module.

27. The method of claim 22, further comprising the step of receiving updated activity data at the first computing device from one of the software modules.

28. A computer-readable medium having computer-executable instructions for performing the steps recited in claim 22.

29. A computer-implemented method for displaying information from a plurality of sources in an activity-based user interface displayed on a computing device, comprising:
opening a first software module, a second software module, and a third software module on the computing device;
simultaneously displaying the user interface of the first software module and the activity-based user interface;
retrieving activity data from the second software module and the third software module; and
displaying the activity data from the second software module and the third software module in the activity-based user interface.

30. The method of claim 29, further comprising the step of polling the second software module to retrieve additional activity data.

31. The method of claim 29, further comprising the step of storing the activity data.

32. The method of claim 29, wherein the activity data comprises content from the second software module and the third software module.

33. The method of claim 29, wherein the activity data comprises at least two of calendar data, email data, data from a browser application, data from a document application, data from a server application, and data from a database application.

34. A computer-readable medium having computer-executable instructions for performing the steps recited in claim 29.

35. A computer system for displaying information from a plurality of sources in a graphical user interface comprising
a conferencing module operating on a server computer and operable for providing meeting data from at least two different software modules;
a first client and a second client coupled to the server computer and operable for receiving the meeting data from the conferencing module; and
a conferencing user interface displayed on the first client and the second client, the conferencing user interface operable for rendering the meeting data received from the conferencing module.

36. The system of claim 35, wherein the meeting data comprises at least two of attendee data, agenda data, data from a browser application, data from a document application, data from a server application, and data from a database application.

37. The system of claim 35, wherein the conferencing module is further operable for receiving meeting data from the first client and the second client.

38. The system of claim 35, wherein the conferencing module renders the conferencing user interface.

39. The system of claim 35, wherein the meeting data comprises content from a software application.
